(19) United States
(12) Patent Application Publication
(10) Pub. No.: US 2004/0095049 A1
(43) Pub. Date: May 20, 2004

(54) Method for producing a starting element

(76) Inventors: Heinz Geier, Leonberg (DE); Eckhardt Kuglin, Lich-Niederbressin (DE); Michael Hausser, Frankfurt (DE); Herbert Triptrap, Frankfurt (GB)

Correspondence Address: Kenyon & Kenyon, One Broadway, New York, NY, 10004, US

(21) Appl. No.: 10/470,526

(22) PCT Filed: Dec. 17, 2001
(86) PCT No.: PCT/DE01/04791

(30) Foreign Application Priority Data
Jan. 29, 2001 (DE) 10104021.7

(51) Int. Cl. H01T 13/00; B05D 5/12; B05D 3/02; B32B 9/00

(52) U.S. Cl. 313/118; 427/458; 427/376.2; 427/58; 428/702

(57) ABSTRACT

A method for manufacturing a starting element, in particular a sheathed-element glow plug, for the combustion process in an internal combustion engine having a ceramic element (1, 3) is proposed, which substantially improves the glazing of the ceramic element (1, 3). According to the present invention, this is achieved by a dry glaze (2) being applied on the ceramic element (1, 3).

The present invention is directed to a method for manufacturing a starting element, in particular a sheathed-element glow plug, according to the definition of the species in claim 1.

### BACKGROUND INFORMATION

Known starting elements for the combustion process in an internal combustion engine, such as a spark plug or a sheathed-element glow plug, include a ceramic element. Until now these ceramic elements were coated with a slip in a wet process, for example using a casting, dipping, spraying, sprinkling or roll-on method. Once the slip has been applied, the ceramic element is fired, the bakable material contained in the slip fusing or sintering to form a vitreous layer, often also referred to as ceramic layer.

However, a disadvantage of such wet chemical treatment methods is that the manufacture of the slip is comparatively expensive, that fouling processes may destroy the slip and that sedimentation processes must be counteracted, which results in waste-water problems and high energy consumption. Draining slip may form droplets and necessitate expensive aftertreatment. In heaters for a sheathed-element glow plug of a diesel engine the draining slip may result in a thin layer thickness, thereby increasing the danger of a short circuit.

### OBJECT AND ADVANTAGES OF THE INVENTION

In contrast, the present invention is based on the objective of proposing a method for manufacturing a starting element, in particular a sheathed-element glow plug, by which the above disadvantages are at least partially avoided.

Starting from a method of the type indicated in the introduction, this objective is attained by the characterizing features of claim 1.

The measures indicated in the dependent claims make possible advantageous embodiments and further developments of the present invention.

Accordingly, a method according to the present invention for manufacturing a starting element is distinguished in that a dry glaze is applied on the ceramic element.

By avoiding a slip, it will not be necessary, for example, to provide for the durability of the slip, which is expensive, and the waste-water problem caused by the slip is obviated as well. Since a dry application of the coating is carried out, using sifting, powder, vibration or similar methods, if appropriate, the baking is comparatively fast, which also results in a lower energy consumption of the method according to the present invention. In addition, the expensive post-working of drops that flow off or the like is avoided.

In an advantageous manner, the dry glaze is applied on the ceramic element electrostatically. This ensures that a more even layer thickness is produced compared to previous methods, in particular along the edges and in the grooves.

Thus, the danger of short circuits occurring in a heating element of a sheathed-element glow plug is non-existent, which represents a substantial improvement.

The dry glaze preferably contains 4 to 6% CaO, 4 to 6% BaO, 8 to 12% Al₂O₃, 53 to 61% SiO₂ as well as 20 to 26% B₂O₃, the dry glaze advantageously including 5% CaO, 5% BaO, 10% Al₂O₃, 57% SiO₂ and 23% B₂O₃. By using a dry glaze with an appropriate composition, it is possible to realize an advantageous conductivity and fluidizability of the dry glaze, which substantially improves the electrostatic coating. Furthermore, the use of this lead-free dry glaze reduces the environmental impact.

The composition of an electrostatically applicable dry glaze—in this case, glazing powder—may be wide-ranging, so that the properties of the glazing powder, among them the baking characteristic, the expansion coefficient and the electrical properties of the powder and the baked-in glaze, may easily be adapted to the substrate to be glazed. Particularly suitable glazing powders, such as glass frit, may be coated with insulating substances, such as organo polysiloxanes according to EP-A 0 382 003, so as to increase their specific resistance. Instead of coating a glazing powder with an insulating substance, electrostatically applicable glazing powders may also include a small amount of a carboxylic acid salt according to WO 98/54105, to increase the specific resistance and to improve the fluidizability. By using a glazing powder according to WO 98/58889, which contains two glass frits having different softening onsets, good quality glazes may be achieved with a high layer thickness. According to WO 94/26679 or WO 97/08115, the adhesive strength of the glazing powder on the substrate before firing may be enhanced by also using a physically or chemically activable organic adhesive agent, such as a thermoplastic polymer.

In a special further refinement of the present invention, an electrically insulating ceramic element is used. In this way, the coating of the ceramic element of a spark plug, for a spark-ignition engine, for example, is also able to be realized.

In another specific embodiment, an electrically conductive ceramic element is utilized. This substantially simplifies the electrostatic coating and simultaneously allows the coating of a heating pin for a sheathed-element glow plug according to the present invention, for example for a diesel engine. In this context, the substantially more even coating of the edges that is able to be realized compared to previous methods is decisive for the functioning of the sheathed-element glow plug. This was not reliably ensured by the conventional manufacturing methods.

### EXEMPLARY EMBODIMENT

An exemplary embodiment of the present invention is shown in the drawing and is elucidated in greater detail in the following with reference to the figures.

The individual figures show:

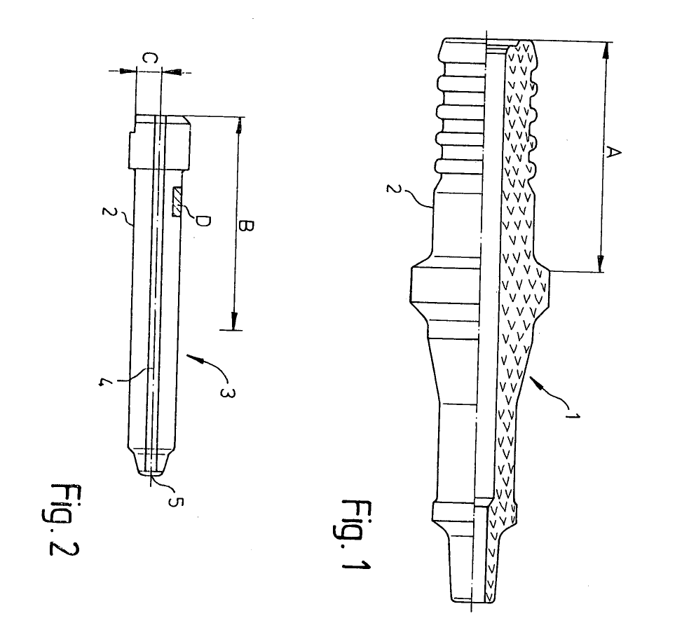

FIG. 1 an electrically insulating ceramic element according to the present invention;

FIG. 2 an electrically conductive ceramic element for a sheathed-element glow plug according to the present invention; and

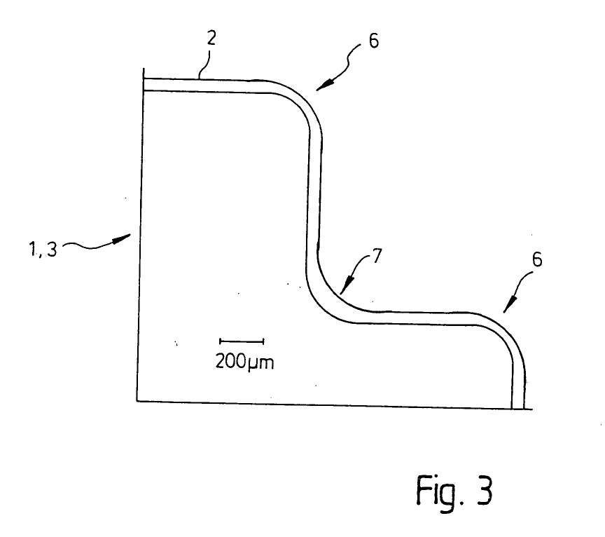

FIG. 3 a cut-away portion of a longitudinal groove of a coated ceramic element according to the present invention.

FIG. 1 shows an electrically insulating ceramic element 1, which has a glaze 2 in a region A. Both the stability of ceramic element 1 and the repelling of dirt and water are improved by glaze 2. This reduces, in particular, damage during installation or disassembly and also the occurrence of malfunctions during operation.

FIG. 2 shows an electrically conductive ceramic element 3 for a sheathed-element glow plug, which is coated in a region B with a glaze 2 applied according to the present invention. In this case, glaze 2 is applied both on the surface area and also in the frontal area of ceramic element 3. After ceramic element 3 has been electrostatically coated and glazed, the glaze is removed again in a semicircular region C and a rectangular region D, by filing it off, for example, and a contacting is in each case affixed to both regions C, D in a manner not shown further.

Ceramic element 3 has an insulating layer 4, the positive pole being realized, for example, by way of the contacting of region C during operation of the sheathed-element glow plug, and the negative pole by way of the contacting in region D. With the aid of a current flow realized via the contacting, ceramic tip 5 begins to glow relatively quickly, so that the starting procedure of a diesel engine is advantageously shortened compared to metallic sheathed-element glow plugs.

In the installed state of the sheathed-element glow plug, glaze 2 allows the sheathed-element glow plug to be insulated from the metallic engine housing.

FIG. 3 shows a cut-away portion of a longitudinal groove of a ceramic element 1, 3. FIG. 3 illustrates that glaze 2 has a relatively even layer thickness both at edges 6 and also in a groove 7. Especially the comparatively thick coating at edges 6 is decisive for the functioning of a sheathed-element glow plug. The relatively thin layer in grooves 7 is also advantageous in this context.

List of Reference Numerals

1 ceramic element

2 glaze

3 ceramic element

4 insulating layer

5 Tip

6 Edge

7 groove

A Region

B Region

C Region

D Region

What is claimed is:

1. A method for manufacturing a starting element, in particular a sheathed-element glow plug, for the combustion process in an internal combustion engine having a ceramic element (1, 3),
wherein a dry glaze (2) is applied on the ceramic element (1, 3).

2. The method as recited in claim 1,
wherein the dry glaze (2) is electrostatically applied on the ceramic element (1, 3).

3. The method as recited in one of the preceding claims,
wherein a dry glaze (2) is used, which contains 4 to 6% CaO, 4 to 6% BaO, 8 to 12 % Al₂O₃, 53 to 61% SiO₂ and 20 to 26% B₂O₃.

4. The method as recited in one of the preceding claims,
wherein a dry glaze (2) is used, which contains 5% CaO, 5% BaO, 10% Al₂O₃, 57% SiO₂ and 23% B₂O₃.

5. The method as recited in one of the preceding claims,
wherein an electrically insulating ceramic element (1) is used.

6. The method as recited in one of the preceding claims,
wherein an electrically conductive ceramic element (3) is used.

7. A ceramic element (1, 3) of a starting element, in particular of a sheathed-element glow plug, for the combustion process in an internal combustion engine, a glaze (2) being arranged on the ceramic element (1, 3),
wherein an electrostatically applied dry glaze (2) is provided.

8. The ceramic element (1, 3) as recited in claim 6,
wherein the dry glaze (2) contains 4 to 6% CaO, 4 to 6% BaO, 8 to 12% Al₂O₃, 53 to 61% SiO₂ and 20 to 26% B₂O₃.

9. The ceramic element (1, 3) as recited in claim 6,
wherein the dry glaze (2) contains 5% CaO, 5% BaO, 10% Al₂O₃, 57% SiO₂ and 23% B₂O₃.

10. The ceramic element (1, 3) as recited in claim 7, 8 or 9,
wherein the ceramic element (1, 3) essentially consists of an electrically insulating ceramics.

11. The ceramic element (1, 3) as recited in claim 7, 8 or 9,
wherein the ceramic element (1, 3) essentially consists of an electrically conductive ceramics.

12. A sheathed-element glow plug, wherein a ceramic element (3) as recited in claims 7, 8, 9 or 11 is provided.
